(19) United States
(12) Patent Application Publication
(10) Pub. No.: US 2026/0016387 A1
(43) Pub. Date: Jan. 15, 2026

(54) MICROFLUIDIC CONSTRICTION DEVICE FOR HIGH THROUGHPUT IN SITU MEASUREMENTS OF DROPLET SURFACE TENSION AND PARTICLE ELASTICITY

(71) Applicant: NORTHEASTERN UNIVERSITY, Boston, MA (US)

(72) Inventors: Sara Hashmi, West Roxbury, MA (US); Evyatar Shaulsky, Arlington, MA (US)

(21) Appl. No.: 18/994,579

(22) PCT Filed: Aug. 15, 2023
(86) PCT No.: PCT/US2023/030252

§ 371 Date: Jan. 14, 2025

Related U.S. Application Data
(60) Provisional application No. 63/398,021, filed on Aug. 15, 2022.

(51) Int. Cl. G01N 11/02; B01L 3/00; G01N 11/00; G06T 7/00

(52) U.S. Cl. CPC G01N 11/02; B01L 3/502761; G06T 7/0002; B01L 2200/0647; B01L 2200/0673; B01L 2300/0861; B01L 2400/0487; B01L 2400/0622; G01N 2011/008; G06T 2207/10016; G06T 2207/10056

(57) ABSTRACT

Disclosed are microfluidic devices useful in measuring surface tension and elasticity, and methods of use thereof.

### CROSS-REFERENCE TO RELATED APPLICATIONS

This application claims the benefit of priority to U.S. Provisional Patent Application No. 63/398,021, filed Aug. 15, 2022, the entire contents of which is hereby incorporated by reference.

### FIELD OF THE DISCLOSED SUBJECT MATTER

The field is high-throughput in situ measurement of droplets. The disclosed subject matter includes a microfluidic constriction device for high throughput in situ measurements of droplet surface tension and particle elasticity.

### BACKGROUND OF THE DISCLOSED SUBJECT MATTER

Liquid-liquid surface tension plays a critical role in the stability of emulsions, foams, and drops. One of the essential parameters controlling the stability of this complex fluid system is surface tension. In a system of two immiscible fluids like oil and water, adjusting the chemistry and concentration of surfactants at the interface can optimize stability. In addition to determining stability against coalescence, surface tension also governs behavior like droplet breakup, and can impact the adhesion of drops to surfaces.

Droplet production is of interest to many consumer product industries, including cosmetics, food, and pharmaceuticals. Droplets can be achieved by mixing two immiscible liquids to create emulsions in bulk. The advantages of bulk methods are simplicity and quantity. However, production by microfluidics devices can allow for monodisperse droplets. One limitation of microfluidics is the relatively low production rate. Even when high speed droplet production can be achieved, up to 10 kHz, the overall flow rate is still typically around 1 mL/hr.

This problem can be solved technologically by parallelized microfluidic channels, and due to that, microfluidics remains a fast-growing field. Some applications, especially in bioanalytics, are well suited for current technology production rates. The advantages of miniaturization allow for rapid experiments while saving both space and capital. Several commercial companies like Berkeley Lights, Micronit, and Fluigent already implement lab-on-a-chip solutions. Berkeley Lights employs microfluidic technology to save time and money for cell profiling by producing arrays of 100,000 nano-pens on a small chip. Combining media perfusion enables clonal cell culture and a four-color fluorescence imaging cell characterization assay. Micronit has developed a MEMS-based cell sorting microfluidic chip based on a magnetically actuated valve to sort cells. Fluigent provides flow controller systems, small scale droplet makers, and scaled-up droplet generating devices, all of which include options for generating double emulsions and other more complex types of droplets.

Due to the above, there is a growing need to measure liquid-liquid dynamic surface tension to optimize production conditions and minimize the use of an excess surfactant in high throughput microfluidics. However, existing methods for measuring surface tension have drawbacks. In particular, such techniques may require some combination of the following four conditions: (1) the channel cross-section is cylindrical in shape; (2) the flow field is either pure extensional or simple shear; (3) the droplets dilute in the sample; and (4) the droplets are not located too close to the channel walls. Our method validates surface tension measurements without these four requirements. The techniques disclosed herein demonstrate the validity of in situ surface tension measurements in regimes of flow that have not yet been considered.

### SUMMARY OF THE DISCLOSED SUBJECT MATTER

The purpose and advantages of the disclosed subject matter will be set forth in and apparent from the description that follows, and be evident by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes a system for a microfluidic device includes a first stage including a first channel having a first end having a first neck junction and a second end, defining a channel length extending along a first direction therebetween, the first channel having a first width that expands from the first end to the second end in a direction perpendicular to the first direction, an aqueous stream inlet in fluid communication with the first channel at the first neck junction, the aqueous stream inlet configured to provide a fluid to the first channel, at first oil stream inlet in fluid communication with the first channel disposed at the first neck junction and at an angle to the aqueous stream inlet, a second stage including a second channel having a first end having a second neck junction and a second end, defining a second channel length therebetween, the second channel in fluid communication with the first channel, a second oil stream inlet in fluid communication with the second channel proximate a second neck junction at the first end and the second channel having a second width that narrows from the second neck junction to the second end.

The disclosed subject matter also includes a method for measuring surface tension of a droplet, including providing an oil solution to a channel, the channel having a first neck junction and a neck junction, wherein the oil solution flows through the channel from the first neck junction at a first end, through a second neck junction to a second end, generating a plurality of droplets in the channel at the first neck junction, the plurality of droplets flowing through the channel within the oil solution, wherein the channel comprises four stages of decreasing widths, the four stages extending from the second neck junction to the second end, capturing at least one image of the plurality of droplets flowing through the channel, analyzing the at least one image of the droplets flowing through the channel and calculating a surface tension of the plurality of droplets.

It is to be understood that both the foregoing general description and the following detailed description are exemplary and are intended to provide further explanation of the disclosed subject matter claimed.

The accompanying drawings, which are incorporated in and constitute part of this specification, are included to illustrate and to provide further understanding of the method and system of the disclosed subject matter. Together with the description, the drawings explain the principles of the disclosed subject matter.

### BRIEF DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIG. 1A is a schematic planform view of a microfluidic device first stage in accordance with the disclosed subject matter.

FIG. 1B is a schematic planform view of a microfluidic device second stage in accordance with the disclosed subject matter.

FIG. 1C is a schematic planform view of a microfluidic device exit in accordance with the disclosed subject matter.

FIG. 1D is a schematic planform view of a device having a plurality of microfluidic device channels disposed thereon in accordance with the disclosed subject matter.

FIG. 2 is a flow chart of a method for measuring surface tension of droplets according to the disclosed subject matter.

FIG. 3 is a visualization of image analysis for measuring surface tension of droplets in accordance with the disclosed subject matter.

FIGS. 4A-4B are images of droplets flowing through a channel at varying resolutions in accordance with the disclosed subject matter.

FIGS. 4C-4D are plots of velocity and deformation of droplets with respect to channel location in accordance with the disclosed subject matter.

FIG. 4E is a representation of images captured by varying objective microscopes in accordance with the disclosed subject matter.

FIGS. 5A-5B are plots of droplet velocity and deformation of droplets with respect to channel location in accordance with the disclosed subject matter.

FIG. 6A is a plots that depicts deformability index with respect to viscous force per length in accordance with the disclosed subject matter.

FIG. 6B-6C are plots that depict surface tension as a function of droplet diameter and volume as measured by the microfluidic device and pendant droplet, respectively, in accordance with the disclosed subject matter.

FIG. 6D is a plot that depicts surface tension as a function of mole fraction of surfactant in accordance with the disclosed subject matter.

FIG. 7 is a schematic representation of a system for a microfluidic constriction device for high throughput in situ measurements of droplet surface tension and particle elasticity.

FIGS. 8A-8C are representations of droplets interacting with the channel in which they flow in accordance with the disclosed subject matter.

FIGS. 9A-9F are plots of change in droplet velocity and deformability index with respect to channel location in the microfluidic channel with varying molar fractions in accordance with the disclosed subject matter.

FIGS. 10A-10D are plots of droplet velocity and deformability index with respect to channel location in accordance with the disclosed subject matter.

FIG. 11 is a table of pendant drop details in accordance with the disclosed subject matter.

FIG. 12 is a table of microfluidic measurements and details in accordance with the disclosed subject matter.

FIG. 13 depicts a computing node according to various embodiments of the present disclosure.

### DETAILED DESCRIPTION OF EXEMPLARY EMBODIMENTS

Reference will now be made in detail to exemplary embodiments of the disclosed subject matter, an example of which is illustrated in the accompanying drawings. The method and corresponding steps of the disclosed subject matter will be described in conjunction with the detailed description of the system.

One aspect of the invention is a microfluidic device includes a first stage a first channel having a first end having a first neck junction and a second end, defining a channel length extending along a first direction therebetween, the first channel having a first width that expands from the first end to the second end in a direction perpendicular to the first direction, an aqueous stream inlet in fluid communication with the first channel at the first neck junction, the aqueous stream inlet configured to provide a fluid to the first channel, at first oil stream inlet in fluid communication with the first channel disposed at the first neck junction and at an angle to the aqueous stream inlet, a second stage including a second channel having a first end having a second neck junction and a second end, defining a second channel length therebetween, the second channel in fluid communication with the first channel, a second oil stream inlet in fluid communication with the second channel proximate a second neck junction at the first end the second channel having a second width that narrows from the second neck junction to the second end.

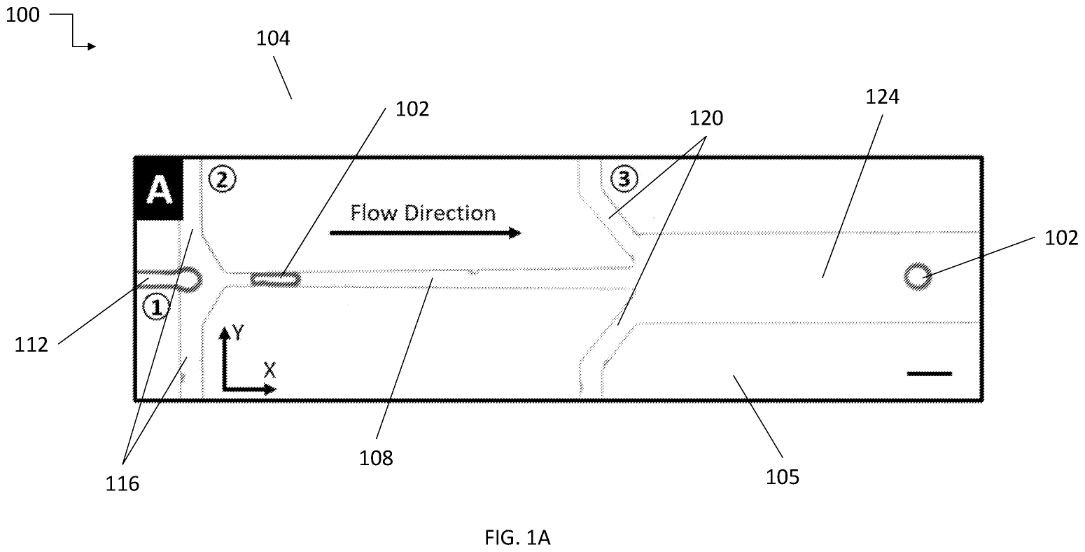

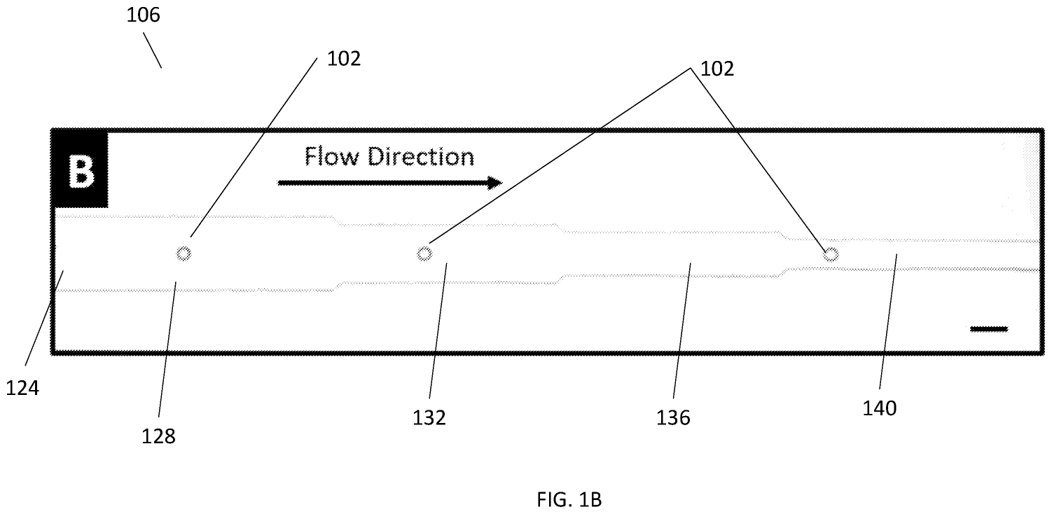

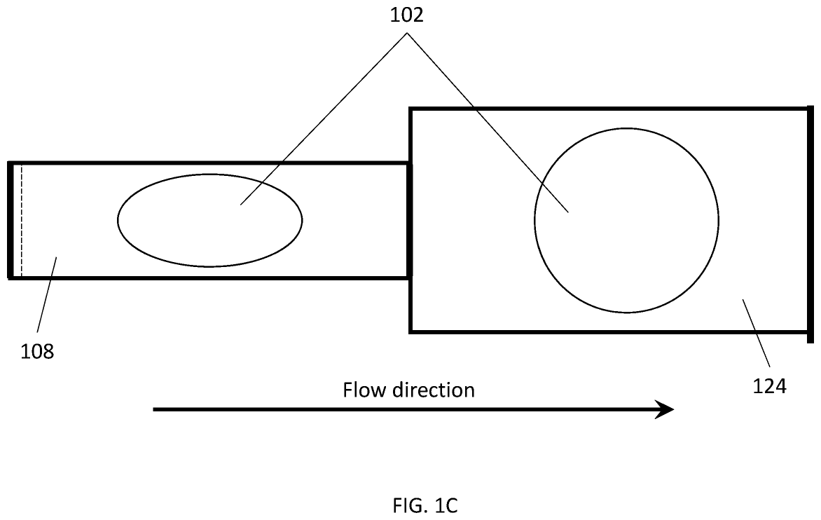

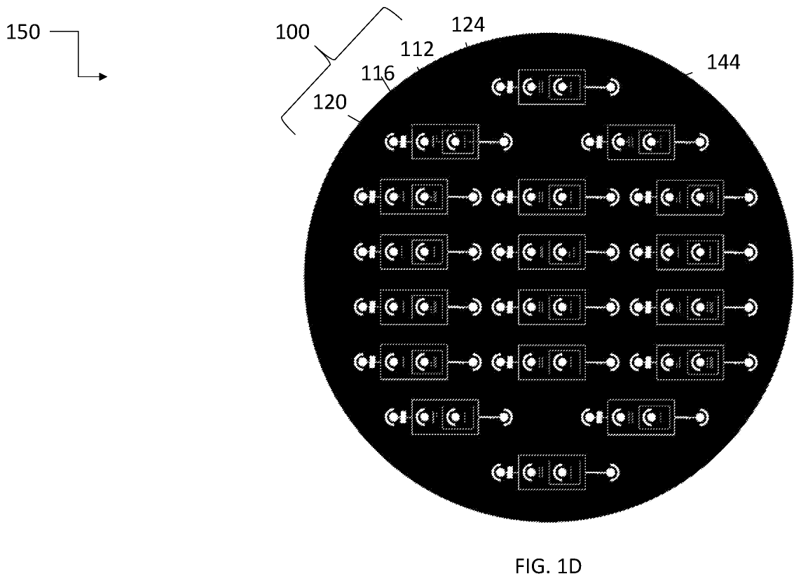

The methods and systems presented herein may be used surface tension measurements of droplets. The disclosed subject matter is particularly suited for microfluidic constriction device for high throughput in situ measurements of droplet surface tension and particle elasticity. For purpose of explanation and illustration, and not limitation, an exemplary embodiment of the system in accordance with the disclosed subject matter is shown in FIG. 1 and is designated generally by reference character 100. Similar reference numerals (differentiated by the leading numeral) may be provided among the various views and Figures presented herein to denote functionally corresponding, but not necessarily identical structures.

Various embodiments disclosed herein relate to measurement of surface tension of droplets (e.g., oil-in-water or water-in-oil) in situ as they flow through a microchannel. The droplets are first made within the microchannel, then the surface tension is measured in a high throughput manner as they droplets flow.

The systems and methods presented herein may validate surface tension measurements in at least one channel with a rectangular cross-section. The systems and methods presented herein may include pressure driven flow. The systems and methods presented herein may include producing droplets with droplet spacing as small as one droplet diameter in between adjacent droplets. The systems and methods presented herein may include droplet sizes between 85-130% of the channel's narrowest dimension.

The systems and methods presented herein may be adapted to and included within traditional microfluidic devices. In various embodiments, concentrated samples can be measured at higher throughput and with less material waste.

The device can be used in concert with current microfluidic platforms to measure surface tension or elastic modulus and screen for droplet stability or particle modulus or other visco-elastic material properties. The device can be used in microfluidic technologies where elastic particles (not droplets) are fabricated. It can also be used in research settings to measure and investigate material properties of complex and designer emulsions and other exotic particle types, like coreshell particles, capsules, and others.

The dynamic surface tension of a liquid-liquid interface can be evaluated by measuring the droplet deformability index as a function of shear rate. Taylor's theory applies to small deformations and was developed in pure shear and pure extensional flows with droplets located far from either wall. Taylor describes the steady state behavior of a droplet/particle within a constriction and its time dependent behavior upon entering or leaving a constriction. Modern implementations have been accomplished in pressure-driven flows through cylindrical capillaries made of glass or PMMA. An increase in continuous fluid flow rate results in an increase in droplet velocity, which is linearly correlated to the shear force. Increasing the shear force results in a linear increase in viscous drag forces, which increasingly elongate the droplet. In various embodiments, the time-dependent part of the Taylor theory may be used, with Taylor plots utilized to extract behavior of the particle or the droplet. We can calculate the dynamic liquid-liquid surface tension from the relationship between viscous drag forces and the droplet deformability index. However, in order to interface cylindrical geometries with microfluidic devices which typically have rectangular cross-sections, extra fabrication steps are needed to embed both within the same device. To accomplish similar measurements in rectangular cross-sections of microfluidic channels, device geometry is designed to establish an extensional flow field within certain regions of the channel, to facilitate measurements of droplets in extensional flow. In the above examples, either single droplets or dilute systems are measured to ensure that droplets do not interact with each other in flow, thus limiting the maximum throughput. To date, however, this type of in situ surface tension measurement has not yet been presented in pressure-driven flows through rectangular cross-section devices.

Referring now to FIG. 1A, a microfluidic device 100 is shown in planform schematic view. Microfluidic device 100 includes a first stage 104. First stage 104 may be one or more bodies 105 having a first channel 108 formed therein. First channel 108 may have a first end and a second end, defining a channel length extending along a first direction therebetween. For the purpose of this disclosure, the first direction may be the flow direction indicated in FIG. 1A. First channel 108 may have a first width extending in a direction perpendicular to the first direction across the first channel 108. For the purpose of illustration, the schematic view of first stage 104, the first width may be vertically measured in the figure (laterally measured relative to the channel). The first channel may gradually expand along the first width as the channel length increases from the first end to the second end. For example, and without limitation, the first channel 108 may expand linearly in width as the channel length increases. For example, and without limitation, the first channel 108 may expand exponentially along the first width as the channel length increases. In various embodiments, the first channel may expand in stages along the first width as channel length increases. In various embodiments, first channel 108 may have a constant first width along the channel length.

With continued reference to FIG. 1A, first stage 104 may include an aqueous stream inlet 112 in fluid communication with the first channel 108. The aqueous stream inlet 112 may be configured to provide a fluid to the first channel 108. In various embodiments, aqueous stream inlet 112 may be disposed proximate the first end of first channel 108. In various embodiments, aqueous stream inlet 112 may be disposed parallel or colinearly with first channel 108. In various embodiments, aqueous stream inlet 112 may be disposed at an angle to the first channel 108 proximate the first end thereof. In various embodiments, aqueous stream inlet 112 may be disposed at a midpoint along the first channel 108 first channel length. Aqueous steam inlet 112 may be configured to form droplets of fluid in the first channel 108. First stage 104 may be configured to form droplets 102 in a flow focusing droplet maker that enables the production of uniform droplets 102 that flow in a single row. In various embodiments, the plurality of droplets 102 may be formed and flow in more than one row, for example in parallel rows. In various embodiments, the plurality of droplets 102 may be formed and flow in an amorphous grouping. In various embodiments, the plurality of droplets 102 may be formed with sufficient time between droplets to flow effectively one droplet at a time in the channels. In various embodiments, aqueous stream inlet 112 may be configured to provide deionized water to the first channel 108. In various embodiments, aqueous stream inlet may be configured to provide water to the first channel 108. In various embodiments, aqueous stream inlet 112 may be configured to provide oil to the first channel 108. In various embodiments, aqueous stream inlet 112 may be configured to provide a solution to the first channel 108. In various embodiments, aqueous stream inlet 112 may be in fluid communication with a pressure generating component. In various embodiments, aqueous steam inlet 112 may be in fluid communication with a pump, syringe or other component configured to generate pressure and move fluid from a first pressure to a second pressure, for example a reservoir into the first channel 108. In various embodiments, fluid may be provided to the first channel 108 from the aqueous stream inlet at a driving pressure of 300-1000 mbar. In various embodiments, droplet size and volume may be correlated to pressure.

With continued reference to FIG. 1A, microfluidic device 100, at the first stage 104, includes a first oil stream inlet 116. The first oil stream inlet 116 is in fluid communication with first channel 108 and disposed proximate the first end and at an angle to the aqueous stream inlet 112. The first oil stream inlet 116 may be disposed proximate the aqueous stream inlet 112 at a first neck junction. At the first neck junction, the aqueous stream, inlet 112, is pinched by the oil from the oil stream inlet 116 into a gradually expanding first channel 108. In various embodiments, the first oil inlet 116 includes two distinct first oil inlets disposed on either side of the aqueous stream inlet 112 perpendicular to the first direction. In various embodiments, first oil stream inlet 116 may include mirror image inlets disposed on opposite sides of the first channel 108. In various embodiments, first oil stream inlet 116 may be disposed at an angle to the first channel 108. In various embodiments, more than one oil stream inlet may be disposed at varying angles to the first channel 108. Oil from the oil stream inlet 116 may envelop the droplets 102 and facilitate steady from thereof through first channel 108. First oil stream inlet 116 may include a curved trajectory that intersects with first channel 108 at a parallel or tangent section to facilitate laminar flow of oil from the inlet into the channel. In various embodiments, first oil stream inlet 116 may be in fluid communication with a pressure-generating component. In various embodiments, first oil stream inlet 116 may be in fluid communication with a pump, syringe or other component configured to generate pressure and move fluid from a first pressure to a second pressure, for example a reservoir into the first channel 108. In various embodiments, oil may be provided to the first channel 108 from the first oil stream inlet 116 at a driving pressure of 1000-2000 mbar. In various embodiments, the flow regime may be correlated to driving pressure and amount of inlets providing the oil. In various embodiments, the oil may be formed from mineral oil, light mineral oil, or the like. In various embodiments, the oil may include mineral oil stabilized by a surfactant, such as Span 80 over a range of concentrations.

With continued reference to FIG. 1A, microfluidic device 100 at the second stage 108, includes a second oil stream inlet 120. The second oil stream inlet 120 is in fluid communication with first channel 108 and second channel 124 and disposed proximate the first end and at an angle to second channel 124. The second oil stream inlet 120 may be disposed proximate the first end of second channel 124 at a second neck junction. In various embodiments, the second oil stream inlet 120 may be two distinct first oil inlets disposed on either side of the first channel 108 perpendicular to the first direction. In various embodiments, second oil stream inlet 120 may include mirror image inlets disposed on opposite sides of the first channel 108. In various embodiments, second oil stream inlet 120 may be disposed at an angle to the first channel 108. In various embodiments, more than one oil stream inlet may be disposed at varying angles to the first channel 108. Oil from the second oil stream inlet 120 may envelop the droplets 102 and facilitate steady from thereof through first channel 108. Second oil stream inlet 120 may be disposed at the point where the first channel 108 width increases by a factor of four. This may be the second end of first channel 108. In various embodiments, additional oil from second oil stream inlet 120 is used to control the continuous phase linear velocity of the droplets 102 and the fluid. An additional oil stream from second oil stream inlet 120 may preserve the continuous fluid flow velocity as the channel width increases and preserves the distance between droplets 102. An additional oil stream from second oil stream inlet 120 may preserve the continuous fluid flow velocity as the channel width increases and preserves the distance between adjacent droplets 102. An additional oil stream from second oil stream inlet 120 may preserve the continuous fluid flow velocity as the channel width increases and preserves the distance between the first and the last droplets 102 in a burst or series of droplets 102.

Second oil stream inlet 120 may include a curved trajectory that intersects with first channel 108 at a parallel or tangent section to facilitate laminar flow of oil from the inlet into the channel. In various embodiments, second oil stream inlet 120 may be in fluid communication with a pressure-generating component. In various embodiments, second oil stream inlet 120 may be in fluid communication with a pump, syringe or other component configured to generate pressure and move fluid from a first pressure to a second pressure, for example a reservoir into the first channel 108. In various embodiments, oil may be provided to the first channel 108 from the second oil stream inlet 120 at a driving pressure of 1000-2000 mbar. In various embodiments, the flow regime may be correlated to driving pressure and amount of inlets providing the oil. In various embodiments, oil may be formed from mineral oil, light mineral oil, or the like. In various embodiments, oil may include mineral oil stabilized by Span 80 over a range of concentrations.

The droplets 102 may be called the inner phase from aqueous stream inlet 112 with an aqueous phase (DI water) that forms droplets 102 once it is pinched of by the outer phase (oil) from first oil stream inlet 116 inlet. The outer phase may be a light mineral oil (Fisher, CAS 8042-47-5) mixed with Span 80 (Sigma CAS 1338-43-8). For example, a mole fraction of Span 80 ranging from χ=10⁻⁵ to 10⁻¹ may be used. The mineral oil may have a viscosity η=39.5±4% mPa·s at room temperature, as measured using a standard strain rate sweep protocol in a cone-and-plate geometry in a rheometer (TA DHR; 20, 60 mm cone).

Referring now to FIG. 1B, microfluidic device 100 is shown in schematic planform view. Microfluidic device 100 includes second stage 106. Second stage 106 may be formed from the same material as first stage 104. In various embodiments, second stage 106 may be integral with first stage 104. In various embodiments, first stage 104 and second stage 106 may be mechanically coupled and in fluid communication with one another. In various embodiments, first stage 104 and second stage 106 may be formed continuously. For example, and without limitation, first stage 104 and second stage 106 may refer to the channel configurations on a single microfluidic device 100. For example, and without limitation, second stage 106 may include a common channel with first stage 104, wherein the characteristics of said channel change from first stage 104 to second stage 106.

Microfluidic device 100 includes a second stage 106. Second stage 106 includes a second channel 124. Second channel 124 may be approximately four times the width of the widest portion of first channel 108. Second channel 124 may include sidewalls that are continuous with the sidewalls of the first channel 108. In various embodiments, second channel 124 may include a channel floor that is continuous with a channel floor of first channel 108. Second channel 124 may have a first end and a second end defining a second channel length therebetween. The first end of second channel 124 may be the same or proximate the second end of first channel 108. Second channel length may be approximately 2100 micrometers from first end to the second end. Second channel 124 may have a second width that narrows from the first end to the second end of the second channel 124. Second channel 124 may have a second width that narrows gradually. Second channel 124 may have a second width that narrows exponentially. Second channel 124 may have a second width that narrows in stages. For example, and without limitation, second channel 124 may have a second width that narrows in four sequential stages. Second channel 124 may include four stages, 128, 132, 136 and 140 extending a distance along the flow direction in the second stage 106. In various embodiments, each stage 128, 132, 136, 140 may extend an equal length along second channel 124. In various embodiments, each stage 128, 132, 136, 140 may each extend a unique length along second channel 124. The second stage may include a four-stage narrowing channel, for example with widths 200, 160, 120, and 80 μm, respectively, with a total length 2100 μm, shown in FIG. 1B. In various embodiments, microfluidic device 100 may be formed in PDMS using soft lithography methods, with a channel height of h=32.4 μm. In various embodiments, the channel height may be between 30-35 μm. In various embodiments, the channel height may be about 32 μm. In various embodiments, second channel 124 may have a second width that narrows from approximately 190 to 70 μm. In various embodiments, the stages of the device 100, such as the second channel 124 may be adjustable, for example, with inserts configured to be placed in any stage of the channel to narrow said channel. In various embodiments, the walls of the channel at any stage may be configured to move within a frame structure, the walls being able to narrow or widen via one or more transverse grooves. In various embodiments, the channels may be manufactured with one or more removable portions configured to widen the channel or channel stage when removed. In various embodiments, the droplet size may be adjusted to tune the relative size of the droplets to the channel walls. For example, to widen a channel, a droplet size may be reduced by adjusting pumps or other pressure driving components configured to provide the solution and oil to the channels as described herein. Alternatively, to narrow the channel, the droplets may be enlarged by increasing the aqueous solution pump or lowering the oil pump to increase the droplet size and effectively narrow the channel or channel stage.

Referring now to FIG. 1C, a microfluidic device 100 exit is shown in schematic planform view. The system described herein may include a transition from a relatively narrow channel to a relatively wide channel. The droplet may be imaged and analyzed at this exit stage, for example between first channel and second channel, wherein the droplet shape is measured as a function of time. For example, and without limitation, the narrower steady state channel may impart a deformation on the droplet and upon exiting into the wider subsequent channel, the droplet returns to its relaxed shape. The Taylor theory may be applied to extract the mechanical properties as described herein. In various embodiments, any arrangement of steady state constrictions and exits may be used in the microfluidic device 100. The exits as described in reference to FIG. 1C may be disposed at the end of the second channel 124 wherein the droplet and/or particle may be exhausted from the device 100.

In various embodiments, the microfluidic device may be formed from a polydimethylsiloxane (PDMS) body and a glass slide having a generally planar shape disposed over the body with the channel therebetween. In various embodiments, both the PDMS and glass slide may be treated with plasma and adhered together, with holes punched through the PDMS so that all inlet and outlet tubing is connected to a top portion of the microfluidic device.

Flow through the device may be controlled using constant driving pressure. For example, and without limitation a Fluigent LineUp Flow EZ pressure control system may be utilized to control the constant driving pressure. As discussed above, the pressures that drive aqueous steam inlet 112 and oil stream inlets 116, 120 may be between about 300-1000 & 1000-2000 mbar, respectively, to obtain desired droplet size and volume fraction. The pressure driving second oil stream inlet 120 may be about 2000 mbar. Given conservation of mass, the volumetric flow rate Q remains constant from one constriction to the next, and droplet flow velocity v increases proportionally with the reduction of the channel cross-sectional area A: v=Q/A. As a result, increasing droplet velocities and shear rates are produced as the droplets 102 travel downstream through the channels shown in FIGS. 1A-1C.

Referring now to FIG. 1D, a microfluidic device 150, with a plurality of distinct microfluidic device 100 emplaced thereon. In various embodiments, the microfluidic device 150 may be a four inch diameter chip that is etched to produce the plurality of microfluidic devices 100 disposed thereon. In various embodiments, the microfluidic devices 100 may be arranged on the device 150 in order to maximize the number of devices 100 that may be manufactured on one chip. In various embodiments, the device 150 may be cut such that the devices 100 are separated therefrom for use according to the method disclosed herein. The inner two inlets are formed by aqueous stream inlet 112 and first oil stream inlet 116, which are fed with a droplet phase and a solution phase, respectfully as described herein. The droplet phase flows to the channel and is pinched-off by the oil phase to generate droplets. The third inlet, formed by the second oil stream inlet 120, a solution phase, is used to tune the spacing between the droplets before they travel further downstream for measurement within second channel 124. The measurement region comprises a straight channel followed by a series of four channels with progressively smaller widths as described herein. At constant flow rate (with no user adjustments needed), the droplets increase in velocity through the constrictions and subsequently elongate due to the increasing shear stress. The droplets then proceed to an outlet reservoir 144, where they can be collected.

With continued reference to FIG. 1D, in various embodiments, microfluidic device 150 may produce droplets in each of the channels disposed thereon, or a subset thereof. In various embodiments, microfluidic device 150 may be image-captured in all channels simultaneously, or a subset thereof. In various embodiments, more than one camera can be used to capture images of any number of channels on the microfluidic device 150 simultaneously or consecutively.

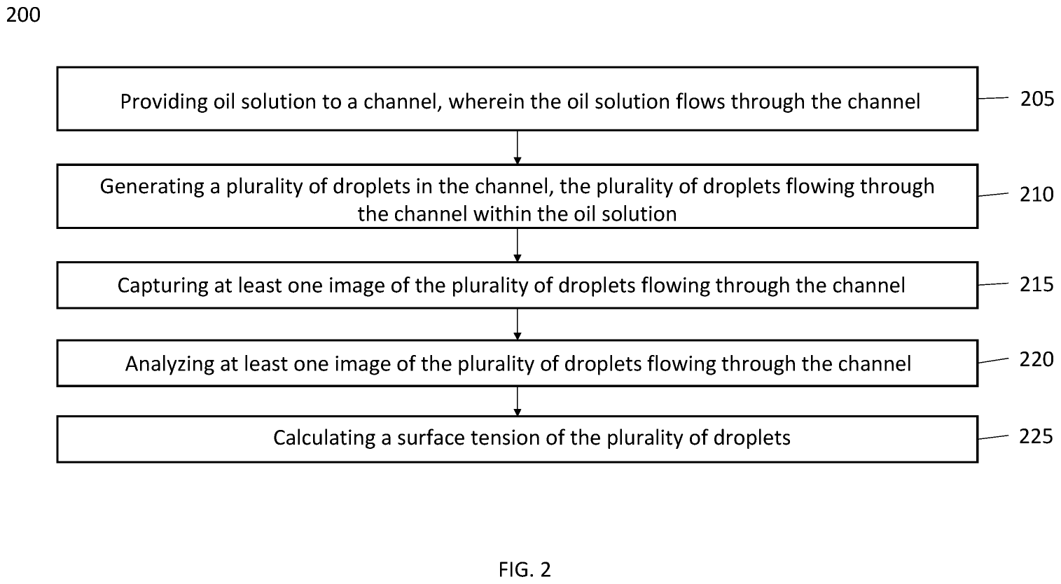

With continued reference to FIG. 2, a method 200 for measuring surface tension using microfluidic device 100 allows for in-line measurements without requiring manual adjustment to input flow rates or driving pressure. This is possible by generating drops flow through increasingly narrow channels ranging from 200 μm to 80 μm that experience increasingly higher shear stress. Image and/or video analysis provides simultaneous measurements of droplet velocity and deformability index, from which surface tension can be calculated. The method may be validated using standard pendant droplet measurements on water-in-oil emulsion drops with Span 80 as the surfactant. In a high magnification (20× objective) analysis, an oscillation in the droplet deformability can be observed as it travels along the microfluidic channel. In addition, the best agreement between the microfluidics measurements and the pendant droplet measurement was received when the deformability index was calculated as the average of the oscillation deformability index. An advantage of microfluidic device 100 is that instead of measuring one droplet at one flow rate, hundreds of droplets in four different flow rate conditions without any adjustment to our control parameters can be measured.

Referring to FIG. 2, a flow chart of method 200 for measuring surface tension of a plurality of droplets is shown. Method 200 for measuring surface tension of a droplet includes, at step 205, providing an oil solution to a channel, wherein the oil solution flows through the channel from a first end to a second end. The oil solution provided to the channel may be the same or similar as any oil solution described herein. In various embodiments, providing the oil solution to the channel comprises providing the oil at a driving pressure of between 1000-2000 mbar. In various embodiments, providing oil solution to the channel may include providing oil to any inlet described herein. For example, providing the oil solution to the channel may include providing oil solution to a first and a second oil stream inlet (116, 120) as described herein above.

With continued reference to FIG. 2, at step 210, includes generating a plurality of droplets in the channel. The plurality of droplets may flow through the channel within the oil solution. The droplets may be made at a droplet maker neck (neck junction) proximate the first end of the first channel described in FIG. 1A, where the aqueous disperse stream is pinched off by the oil continuous stream. In various embodiments, aqueous stream inlet 112 may be configured to provide a solution to the first channel 108. In various embodiments, aqueous stream inlet 112 may be in fluid communication with a pressure generating component. In various embodiments, aqueous steam inlet 112 may be in fluid communication with a pump, syringe or other component configured to generate pressure and move fluid from a first pressure to a second pressure, for example a reservoir into the first channel 108. In various embodiments, fluid may be provided to the first channel 108 from the aqueous stream inlet at a driving pressure of 300-1000 mbar. In various embodiments, droplet size and volume may be correlated to pressure.

Additionally, a second junction may be included where the channel width increases, proximate the second end of the first channel and first end of the second channel to preserve continuous fluid flow velocity and distance between droplets. The downstream microfluidic channel with four different channel widths increases fluid flow velocity. The second channel length may be approximately 2100 micrometers from first end to the second end. Second channel 124 may have a second width that narrows in stages. For example, and without limitation, second channel 124 may have a second width that narrows in four sequential stages. Second channel 124 may include four stages, 128, 132, 136 and 140 extending a distance along the flow direction in the second stage 106. In various embodiments, each stage 128, 132, 136, 140 may extend an equal length along second channel 124. In various embodiments, each stage 128, 132, 136, 140 may each extend a unique length along second channel 124. The second stage may include a four-stage narrowing channel with widths 200, 160, 120, and 80 μm, respectively, with a total length 2100 μm, shown in FIG. 1B. In various embodiments, microfluidic device 100 may be formed in PDMS using soft lithography methods, with a channel height of h=32.4 μm. In various embodiments, the channel height may be between 30-35 μm. In various embodiments, the channel height may be about 32 μm. In various embodiments, second channel 124 may have a second width that narrows from approximately 190 to 70 μm.

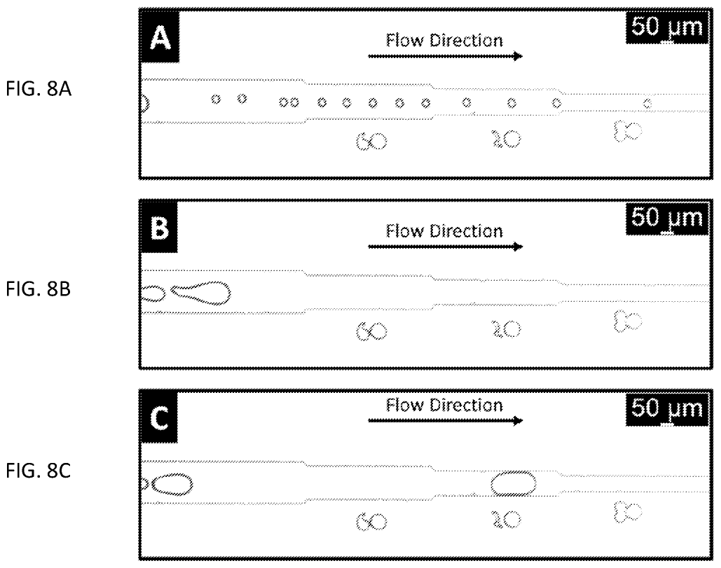

Due to the hydrophilic interaction between the drops and the glass slide, the channel may be pre-flushed with a hydrophobic coating. For example, the channel may be pre-flushed with Aquapel to provide a hydrophobic coating on the PDMS and glass surfaces. This method allows us to capture useful videos even at low surfactant concentrations. In various embodiments, it has been observed that droplets can sticking to the channel walls and block the channel in very low surfactant concentration conditions, even for small diameter drops (as shown in FIGS. 8A-8C). This sets a lower limit of χ=3.7×10⁻⁴ for the surfactant concentration measurable in the microfluidic device 100.

The flow rate ratio between the aqueous and oil streams in the neck junction enables some control over the droplet diameter. As the surfactant concentration is increased, the lower the liquid-liquid surface tension, the ability to control the droplet size improves. Droplets with diameter smaller than h=32.4 μm move freely through the device without touching the top and bottom walls. Droplets with a diameter larger than h are more disk-like and touch the channel top and bottom. The hydrophobic coating on the glass and PDMS and the hydrophobic surfactant tail provide a lubricating layer between large droplets and the walls. Nonetheless, pressures driving aqueous stream inlet 112 and oil stream inlet 116 may be controlled to maintain droplet diameters a<h. In a few cases, droplets were observed that were slightly larger than h.

With continued reference to FIG. 2, method 200 at step 215, includes capturing at least one image of the plurality of droplets flowing through the channel. Capturing at least one image of the plurality of droplets includes capturing a video of the plurality of droplets flowing through the channel. In various embodiments, capturing the video of the plurality of droplets flowing through the channel may include capturing the images between approximately 91-167 Hz. In various embodiments, capturing at least one image of the plurality of droplets may include capturing the at least one image via a microscope. For example, and without limitation, the microfluidic device 100 may be placed on a Leica inverted microscope (DMi8) and imaged using either a 5× or 20× objective. In various embodiments, the objective may be between 5-20×. In various embodiments, the total length of second stage 106, which includes the constrictions section allows us to image all four constriction stages (128 132 136, 140) simultaneously, using the 5× objective, with resolution of about 1 pixel per μm, in various embodiments, about 0.96 pixel per μm. In various embodiments, capturing at least one image may include imaging one constriction stage at a time with the 20× objective, with resolution 3.33 pixel per μm, capturing four individual videos to image the total device.

In various embodiments, in each case the field of view may be reduced to minimize the exposure time to collect images at the highest frame rate possible by the microscope camera (Leica DFC9000 sCMOS). In various embodiments, exposure times may range from 6 to 11 ms between frames, and the capture rate may therefore range from 91-167 Hz. In various embodiments, the short videos may be exported as a sequence of images for each experimental condition and then analyzed.

With continued reference to FIG. 2, method 200 includes, at step 220, analyzing the at least one image of the plurality of droplets flowing through the channel. Each image, series of images or video may be analyzed to obtain droplet position and/or shape in every frame. In various embodiments, one or more computer programs may be employed to automated analyze images, for example, Python OpenCV. In various embodiments, the image analysis python code evaluates over twenty thousand measurements in a single experiment. This high throughput provides more detailed deformation results and enables the discovery of new phenomena. Measurements that can be independently validated despite measuring in pressure-driven flow through channels of a rectangular cross-section.

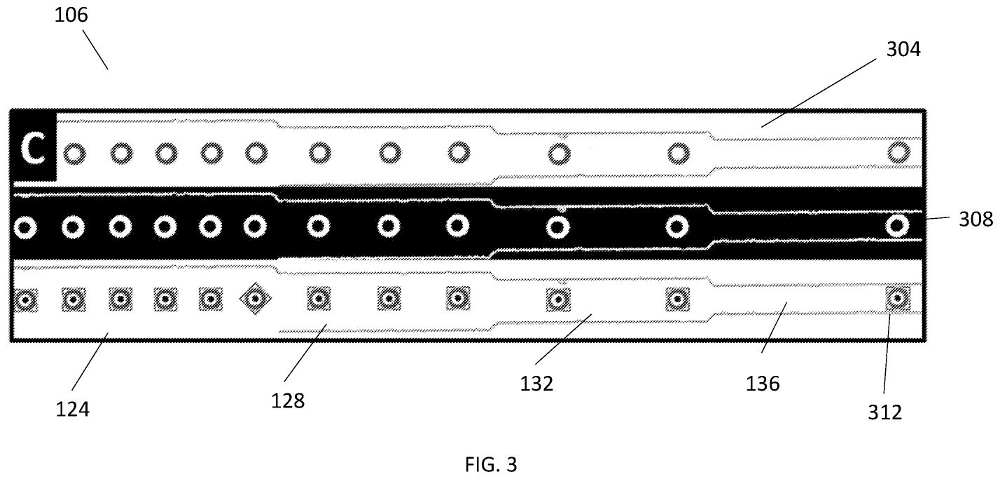

Analyzing the at least one image may include rotating and cropping the frames so that flow is in the x-direction only as in the top image in FIG. 3, identified by 304. Analyzing the at least one image may include binarizing the grayscale images, as shown in the middle of FIG. 3, identified by 308. Binarizing the image 308 may include identifying the plurality of droplets against the channel. In various embodiments, binarizing the image 308 may include identifying the droplets in white with the sidewalls of the channel, with the remainder of the channel identified with black empty space. Binarizing the image 308 may include identifying varying depths of field or three-dimensional bodies in order to identify the plurality of droplets.

In various embodiments, all contours may be identified in the binary image 308, and the results may be filtered in order to choose the outermost contour of the droplet, indicated by the bounding arc within the rectangular frame in the bottom image of FIG. 3, identified by 312. After defining all the relevant contours, the smallest rectangular frame for each individual contour, as indicated by the corner bounding boxes in the bottom of FIG. 3, 312. The dimensions of the rectangle may correspond to the major and minor axes of the droplet, d1 and d2, respectively. The droplets may experience no deceleration, and thus the major axis may be in the flow direction. The center of the rectangle may be the droplet centroid, which is analyzed using one or more particle tracking algorithm to obtain the trajectory of each droplet of the plurality of droplets. The frame rate and resolution of each image is utilized to calculate the instantaneous linear velocity v of each droplet of the plurality of droplets.

In various embodiments, analyzing the at least one image includes calculating the deformation of each droplet of the plurality of droplets. The deformability index D of the droplets is calculated from the major and minor droplet diameters:

$$D = ( {d}_{1} - {d}_{2} ) / ( {d}_{1} + {d}_{2} )$$

The degree of deformation indicated by D is in turn related to the surface tension σ via the viscous shear stress applied by the continuous phase, the mechanism causing deformation, through the classical result of Taylor,

$$D = \frac{19 λ + 16}{16 λ + 16} C a$$

where λ is the viscosity ratio between the dispersed (inner) and continuous (outer) phases and the Capillary number Ca=ηγ′ r/σ where η is the outer, continuous phase viscosity and r the droplet radius. We measure the instantaneous shear rate γ′ using the instantaneous droplet velocity and the narrowest channel dimension, namely the half-height of the channel: γ′=2 v/h. Given the outer phase oil viscosity η 40 mPa·s, Δ=0.025 and the prefactor is 1.005. Thus Eq. 2 represents a small correction, 0.5%, to D=Ca. Writing in terms of parameters measured: D=ηva/hσ, where a is the droplet diameter.

With continued reference to FIG. 2, at step 225, includes calculating a surface tension of a plurality droplets flowing through the channel. Given that each droplet experiences four different values of increasing velocity and shear rate, the surface tension may be calculated as the slope of the linear correlation between the viscous shear forces experienced by each droplet and its deformability index. Wherein σ is calculated as the reciprocal of the slope of D versus ηγ′a.

$$σ = \frac{η {γ}^{\cdot } a}{D}$$

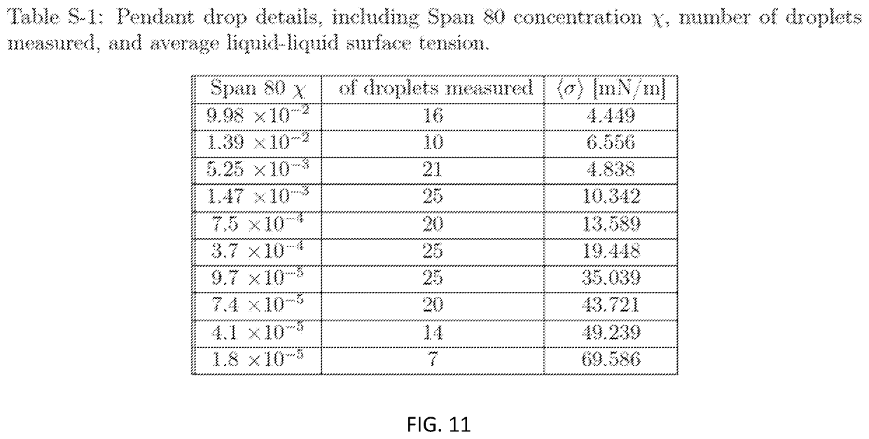

In various embodiments, one or more measurements may be validated using pendant droplet measurements. The interfacial tension between water and oil as a function of Span 80 (Sigma CAS 1338-43-8) mole fraction in the range χ=10⁻⁵ to 10⁻¹ was measured by Krüss DSA-100 instrument. A DI water droplet with volume on the order of 1 μL is placed in a bulk mineral oil (Fisher CAS 8042-47-5) using a 33-gauge needle. Ten different surfactant concentrations were prepared in oil and inserted into a standard cuvette. A minimum of five droplet backlit shadow images were acquired for each surfactant concentration. We performed this sequence twice: as a result, between 7 and 25 droplets were measured at each surfactant concentration (FIG. 11). The interfacial tension σ was calculated using droplet shape analysis performed by the Kruss software and based on the Jennings and Pallas algorithm. This algorithm takes into account three shape parameters: the cylindrical coordinates of droplet profile X, Z and the tangent angle with the Laplace pressure across an interface. The results were averaged for each surfactant concentration separately for each sequence. We also used the microfluidics method described above to measure the liquid-liquid surface tension in the same Span 80 concentrations. Similar to the situation with the microfluidics measurement, at very low surfactant concentration, ×<2×10⁵, the droplet sticks to the needle and the walls of the cuvette, preventing accurate measurements of very high surface tension.

In various embodiments, the measurements may be made on, and calculations include, elastic particles in addition to droplets. To measure elastic particles instead of droplets, the restoring stress is represented by the elastic modulus; that is, σ/a is replaced by the modulus, E. With all other quantities in the Taylor theory known, the results of the image analysis therefore provide measurement of surface tension. In various embodiments, an elastic particle may be flowed through the device as described herein. In various embodiments the particle may be an elastic particle that undergoes deformation when subjected to shear stress. In various embodiments, the particles may be polymers such as biopolymers and/or hydrogels. The particles may be observed and imaged in the device 100 according to the disclosed subject matter, wherein the analysis is performed on the deformed droplets and restoring stress substituted with elastic modulus as described above to calculate surface tension of the particle. In various embodiments, the device may be configured to high throughput of particles instead of droplets, wherein the first neck junction may be utilized to propel particles instead of pinching off droplets of solution within the oil. In various embodiments, the device may be sized down to maintain channel size relative to the particle. In various embodiments, one or more increasingly powerful microscopes may be utilized to image the particle with software configured to identify the edge contours of the particle.

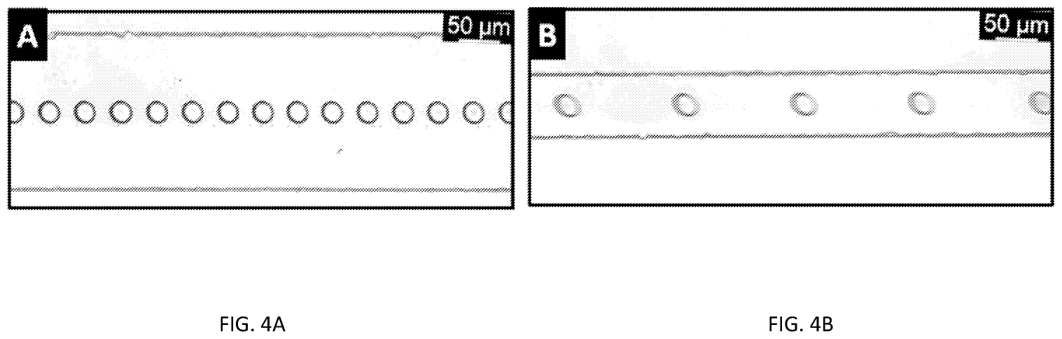

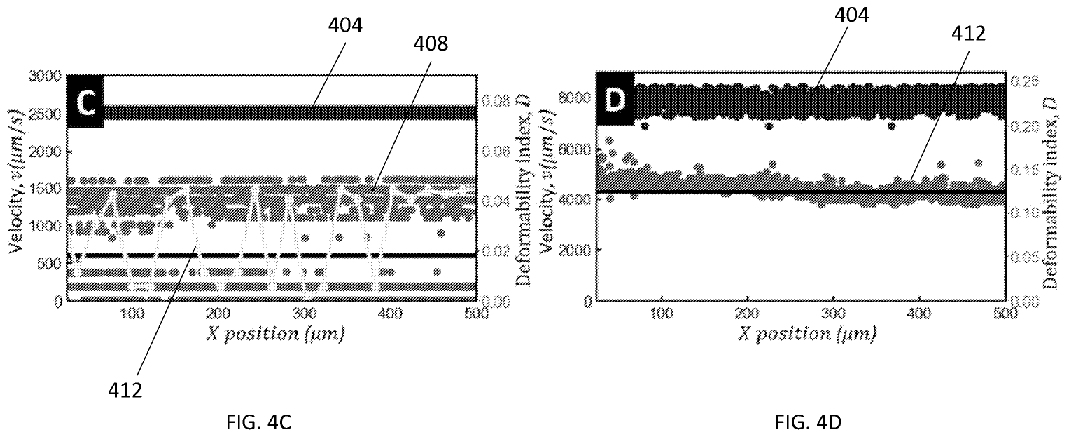

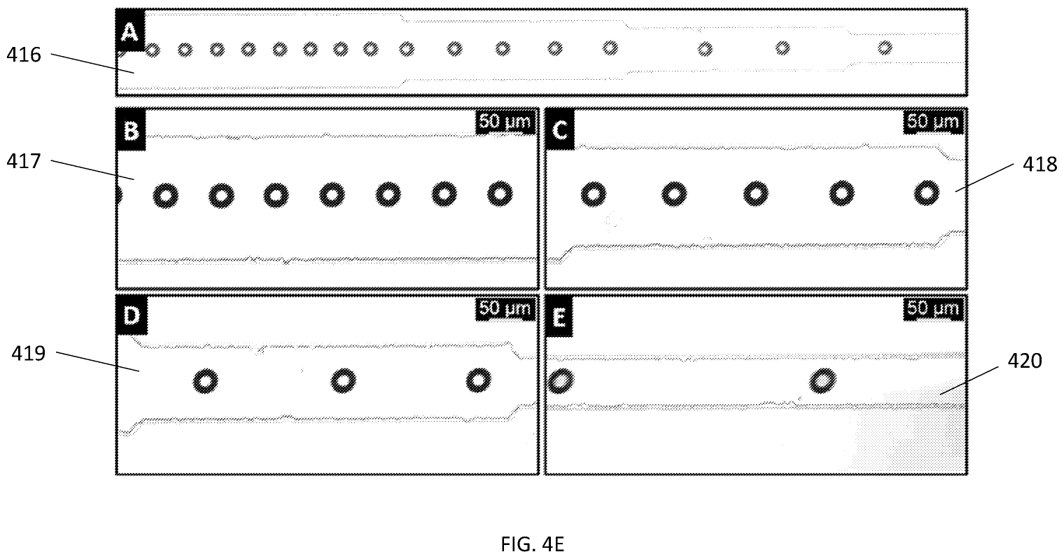

FIGS. 4A-4B depict microscopy images using a 20× objective, capturing one constrictions one each, with width of 190 and 70 μm, respectively. FIGS. 4A-4B show the higher resolution microscopy images captured with the 20× objective, imaging the widest channel with a width and the narrowest width, respectively. Images may be captured at 8 ms per frame for both portions of the channel. Due to the difference in velocity, the drops in FIG. 4A travel an average distance of 20 μm per frame, and in FIG. 4B this average distance may increase to 64 μm. The average number of drops per frame may decrease from 13.8 in the largest constriction (FIG. 4A) to 4.2 in the smallest (FIG. 4B).

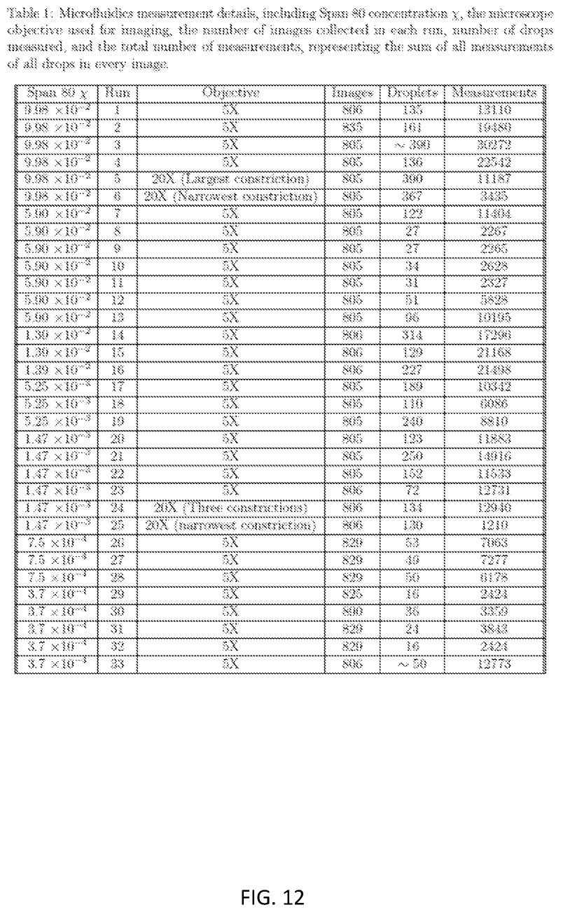

In the high-resolution images, oscillations can be observed in the droplet shape as they travel along the microfluidic channel. At lower shear rates, in the larger constrictions, these oscillations are resolvable at the given exposure time of 8 ms, as seen in FIG. 4A: the shape of each droplet is seen clearly in every frame. However, at higher shear rates, in the smaller constrictions, the oscillations occur faster than the 8 ms exposure time of the camera, and droplets appear blurry, as seen in FIG. 4B, indicating that 8 ms captures more than one configuration of the droplet shape. FIGS. 4C and 4D show plots of velocity v, 404, and deformability index D, 408, with respect to the x-position in the channel. The 404 and 408 data sets represent every measurement of every droplet in each frame. In other words, each 404 and 408 data point represents a single droplet as seen in one of the 806 images captured during the experiment. The data in FIG. 4C represents 11187 individual measurements of drops (FIG. 12: Table 1, row 5), whereas FIG. 4D represents 3435 measurements (FIG. 12: Table. 1 row 6). This difference is due to the decrease in the average number of drops per frame from the widest to the narrowest channel, seen by comparing FIGS. 4A and 4B.

In FIG. 4C, in the widest constriction, the average droplet velocity is v=2520+/−110 μm/s, with shear rate γ′=76 s-1. Two deformability index populations are observed in the 404 data trace, with D˜0.005 and D˜0.04. While there is more scatter in the population of larger D values, the average value, shown by the black line, is somewhat closer to the value of the smaller population: [symbol] D [symbol] =0.018. The tracing of D 412 for a single droplet is shown, demonstrating the oscillation of the droplet shape as it travels down the channel. For this particular droplet, D 412 switches back and forth between the two populations approximately every 20 μm along the length of the channel. As the droplet travels between x˜220 and 300 μm, D 412 switches from one population to the other in each of five frames. Given the 8 ms frame rate, this indicates cycling of D 412 at a rate of nearly 125 Hz, or possibly even faster.

FIG. 4D shows v and D for the collection of droplets imaged while flowing through the narrowest channel (140). Here the droplet velocity is v=7900+/−220 μm/s at a shear rate γ′=240 s-1. In this case, one population of the deformability index, D˜0.124 is observed. This value represents the higher deformability population due to the image analysis algorithm in which the outer envelope of the droplet is used to calculate its shape. Comparing the lower speed flow in the wider constriction to the higher speed flow in the narrower constriction, the droplet velocity increases by approximately a factor of 3, as does the linear distance traveled by the droplet from one frame to the next. However, the frame rate is held constant at 8 ms per frame. The oscillation rate is faster for higher shear rates. However, the oscillation rate may be dictated mainly by the linear distance traveled by the droplet, in which case approximately three oscillation cycles are merged into one image frame at higher speeds v. The appearance of several oscillations during a single exposure can explain both the blurriness of the drops seen in FIG. 4B and the appearance of a single population for D seen in FIG. 4D. While it occurs at speeds beyond the measurement resolution in the narrowest constriction and at the highest linear velocity, the oscillation of droplet shape may increase proportionally with the droplet's velocity.

Droplet shape is known to oscillate as a function of applied external forces. For instance, when constant electric stress is applied to a droplets, they undergo either steady or damped oscillations. This phenomena depends on the Ohnesorge number Oh=η/√ρσa, the ratio of viscous stress to inertial and surface stresses, and the Reynolds number Re=ρvaη, the ratio of inertial to viscous stresses, where ρ is the density of the droplet or suspended phase. Theoretical modeling suggests that no oscillation occurs when Re<<1 or Oh>1, but that oscillations in droplet shape do occur when Re>>1 and Oh<1. Under our experimental conditions, Oh˜0.2 and 10⁻³<Re<10⁻². However, damped oscillations of droplet shape can also occur in confined shear flows even at low Re. These damped oscillations have been observed with cessation of the flow in higher viscosity fluids (η=83 Pa·s and λ=1), but at frequencies˜10⁻⁴-10⁻³ Hz, 5-6 orders of magnitude slower than our current observations suggest.

Referring to FIG. 4E, microscopy images from a microfluidic device under the same conditions are shown. When imaged at lower spatial resolution, using the 5× objective, droplets appear well-defined in each image. Microscopy images from the same microfluidics device under the same experimental conditions are shown. Image 416 is a microscopy image using 5× objective capture the full length of the constriction area including 4 different constriction zones with the width of, 200, 160, 120, and 80 μm. Images 417, 418, 419 and 420 are microscopy images using 20× objective capture one constriction zones with the width of, 200, 160, 120, and 80 μm respectively.

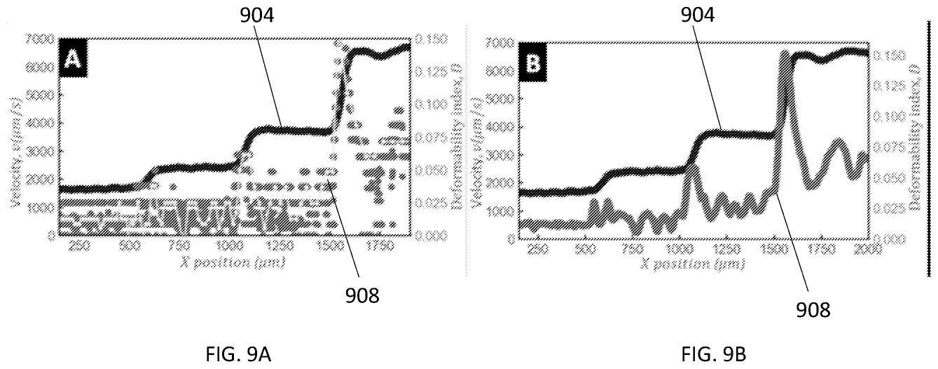

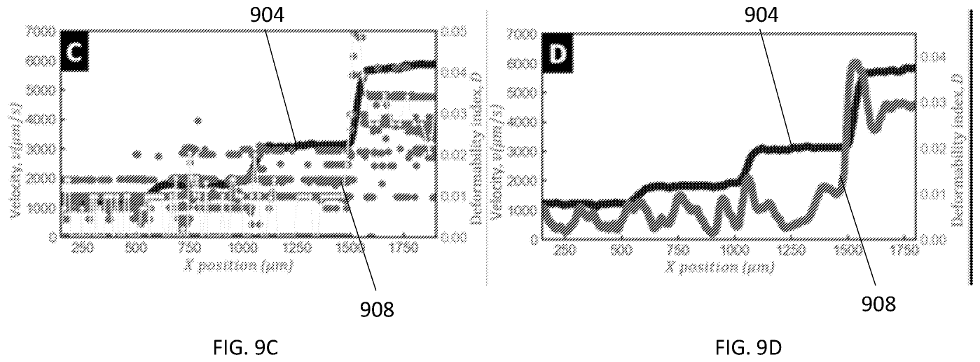

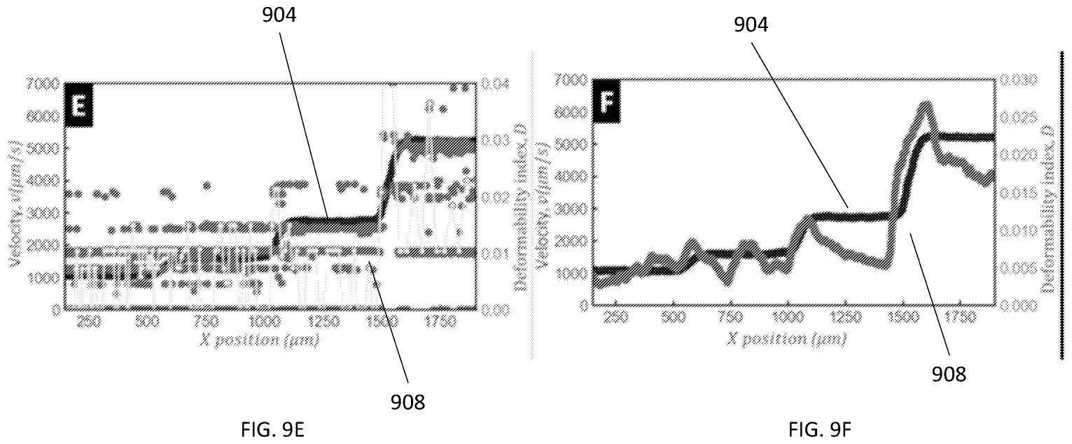

Due to the oscillation of the droplet shape discussed above, the raw data of deformability with respect to the flow direction appears as multiple populations. However, tracing the value of D for a single droplet again shows the oscillation of its shape (shown further in FIGS. 9A-9E).

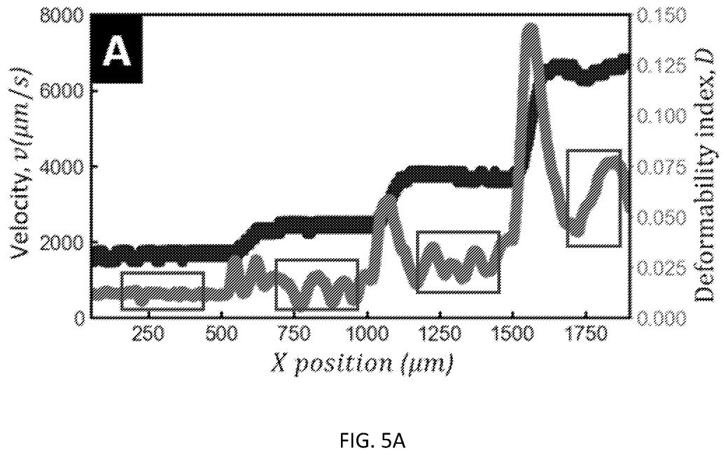

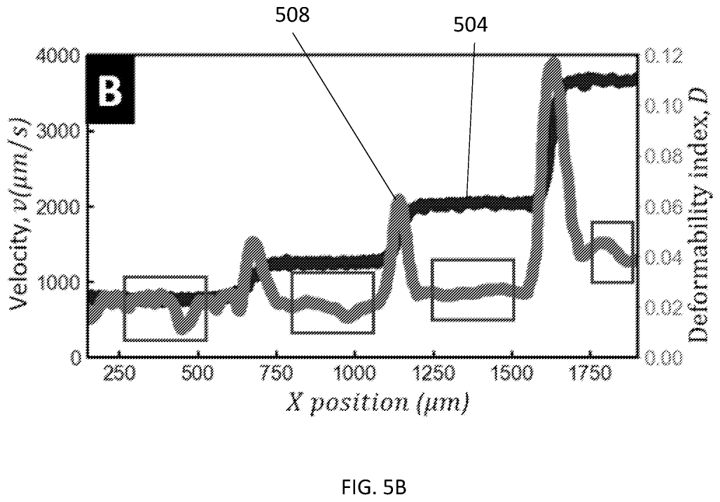

FIGS. 5A-5B shows two representative measurements of v (504) and D (508) obtained at lower spatial resolution with the 5× objective. The results in FIG. 5A and FIG. 5B correspond to χ=5.9×10⁻² and χ=9.98×10⁻², respectively. For each measurement, all four constrictions are imaged simultaneously. The plots shown each represent averaged values of D rather than its full oscillation. To smooth D, a linear fitting over 65 points using a Savitzky-Golay filter with a polynomial degree of one is used, which is essentially a moving average. As the droplets travel from one constriction to the next, v increases smoothly while peaks appear in D. These peaks represent acceleration as a droplet moves from a lower into a higher velocity regime, as is confirmed by comparing the peak locations in D to increases in v. This is a known phenomenon in which the front part of the droplet moves faster than the rear part and leads to an effectively higher droplet deformability in the acceleration regime. The results are averaged within each constriction stage after D reaches steady-state in each new velocity condition. The red rectangles indicate the regions over which we average the values of D for calculations of surface tension σ. The graphs in FIGS. 5A and 5B are each the result of an 805-frame video with averages of 14.1 and 28 droplets per frame and a total of 11,404 and 22,542 individual droplet measurements, respectively.

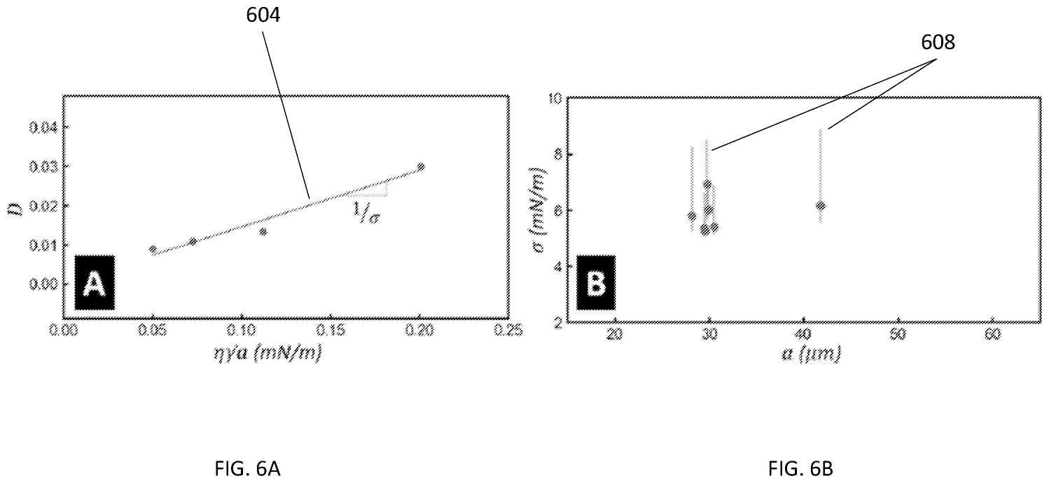

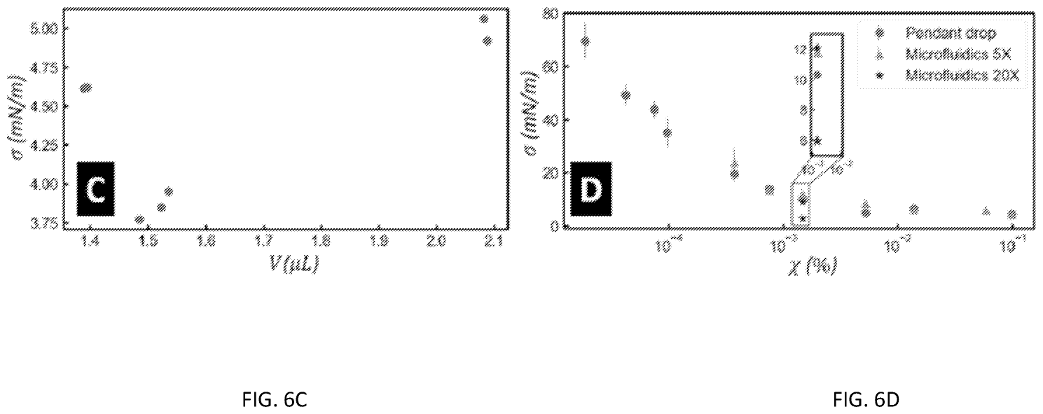

We use the measured values of D and v to measure surface tension σ, using Eq. 3. The summary of our experimental results are shown in FIGS. 6A-6D. FIG. 6A shows the results of a single 5× objective experiment, with D plotted with respect to ηγ′a for χ=5.90×10⁻². Each of the four points in FIG. 4A represents average values obtained from 96 droplets measured at least 200 times in each of the four constriction stages in a single device, corresponding to Run 13 in Table 1 presented in FIG. 12. The red line 604 in FIG. 6A is a linear fit to the data; the slope is 1/σ, the reciprocal of the surface tension, which gives σ=6.9 mN/m, representing an ensemble measurement. The R-squared value of the linear fit is 0.99, indicating that the value of ηγ′a/D obtained from each of the four stages is very close to the overall slope. FIG. 6B shows measurements of σ as a function of droplet diameter a for the same sample, χ=5.90×10⁻², but this time for a collection of seven individual droplets. Each data point represents σ obtained from the slope of D versus ηγ′a for that particular droplet. The blue bars 608 represent the ranges of the four values of σ, each obtained from a single constriction stage. For all seven drops, the average value of σ=5.84+/−0.55 mN/m. The range of σ obtained from individual constriction stages, shown by the blue bars, extends slightly above the spread in the values of σ obtained from the slope of D versus ηγ′a. Furthermore, even for the one droplet with a=41.8 μm that is larger than the channel height h˜32 μm, σ=6.15 mN/m. Interestingly, while literature suggests the optimal spacing of droplets between channel walls is 0.2<a/h<0.8, 23 FIG. 6B shows that measurements of σ at a/h>1 are comparable to those obtained when a/h˜0.85-0.93. The fact that σ does not vary with a indicates that, despite h being ˜20% smaller than a, the slight compression of the droplet does not significantly alter its average deformation as compared to an uncompressed droplet.

FIG. 6C shows the results of the pendant droplet measurements. Droplets of water are injected into a bath of mineral oil with Span 80 at χ=1.47×10⁻³. Built-in image analysis software measures the volume of each droplet V, and a combination of shape analysis and Laplace pressure gives the surface tension σ. Measurements of seven individual droplets are shown, with [symbol] V [symbol] =1.61±0.28 muL and [symbol] σ [symbol] =4.42±0.47 mN/m. There is no strong dependence of σ on V.

FIG. 6D shows the comparison between the measurements made by the pendant droplet technique and those made by the microfluidic technique, plotting σ with respect to the mole fraction χ of Span 80. The pendant droplet measurements are shown in blue: each point is an average of at least ten independent droplet measurements for each χ value. The standard deviation, indicated by the error bars, decreases as χ increases: the maximum spread in the data is ˜15%, at χ=9.7×10⁻⁵, decreasing to ˜6% at χ=9.8×10⁻². The orange triangles and purple stars represent microfluidic measurements, indicating data taken with the 5× and 20× objectives, respectively. Microfluidic data collected using the 5× objective represents an average of at least three runs, each of which represents an ensemble measurement of between 16-390 droplets. Table 1 depicted in FIG. 12 provides the details on the number of images, total number of drops, and total number of measurements represented by each of the microfluidic data points at each value of χ. Using the pendant droplet, measurements are obtained down to χ=×10, while for the microfluidic device, measurements are obtained down to χ=3.7×10⁻⁴. At even lower values of χ, droplets have a tendency to stick to the side walls of the cuvette or microfluidic device, despite hydrophobic surface chemical pre-treatments-various images of this phenomena can be seen depicted in FIG. 8A-8C. There is a good agreement between the measurable surface tension results of the pendant droplet and the microfluidics device over the entire range of χ.

In FIG. 6D, the data points shown in the inset rectangle provide a comparison between the low and high resolution microfluidic imaging methods. The blue data point indicates the pendant droplet and the orange triangle the microfluidics 5× objective measurements. The two purple stars in the inset indicate microfluidic measurements made using the 20× objective: the upper value, σ=9.04 mN/m, represents the first three constrictions stages, while the lower value, σ=2.73 mN/m, represents the last constriction stage measurement. As explained above, when measured using the 20× objective, images obtained of the fastest flows in the last constriction stage appear to be blurry. Given the overlay of multiple oscillation stages in the droplet shape within a single exposure, the measured value of D skews to a higher value, thereby leading to a lower measurement of σ. However, for the low shear rate stages, use of the 20× objective increases the spatial resolution and improves the signal-to-noise ratio of D as compared to the 5× objective. Nonetheless, the values for σ obtained from the 5× objective and those obtained using the 20× objective over the first three constriction stages differ by only 0.8%.

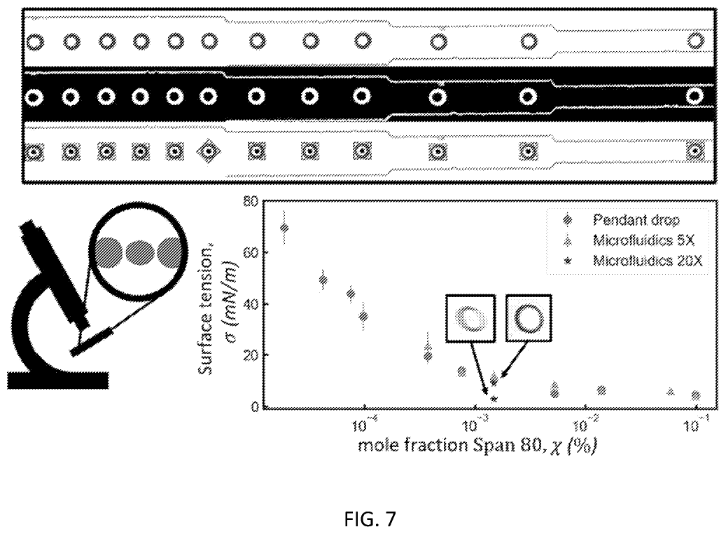

Referring now to FIG. 7, a schematic system diagram is depicted. FIG. 7 depicts an image analysis of droplets flowing through the channel of the microfluidic device via one or more image capture devices, such as cameras and/or microscopic cameras. The image analysis allows for velocity and deformation measurements and/or calculations which allow for surface tension calculations of the droplets. The results of the microfluidic device and analysis may be comparable to standard droplet measurements, thus providing evidence of its efficacy in calculating the surface tension.

Referring now to FIGS. 8A-8C, as discussed at even lower values of χ, droplets have a tendency to stick to the side walls of the cuvette or microfluidic device, despite hydrophobic surface chemical pre-treatments-various images of this phenomena can be seen depicted in FIG. 8A-8C. Images of droplet sticking due to hydrophilic-hydrophilic interaction between the aqueous phase and the glass wall. In FIG. 8A, the start of droplet sticking and droplet aggregation that block the microfluidics channel is shown. In FIG. 8B, a stuck droplet that may block the channel is seen flowing through the channel. In FIG. 8C. a stuck droplet and a big droplet due to aggregation down in the channel is shown. Images in FIGS. 8A, 8B, and 8C may all have been captured at a single concentration, namely at χ=9.71×10⁻⁵.

Referring to FIGS. 9A-9F, plots of droplets velocity and deformability index with respect to X position in the microfluidic channel are depicted. Change in droplets velocity (904) and deformability index (908) in respect to X position in the microfluidic channel can be seen. The yellow line represents D for a single droplet track. FIGS. 9A, 9B oil surfactant (Span 80) mix with a molar fraction of 0.059. FIGS. 9C, 9D oil surfactant (Span 80) mix with a molar fraction of 7.51*10⁻⁴. FIGS. 9E, 9F oil surfactant (Span 80) mix with a molar fraction of 3.7*10⁻⁴. Where FIGS. 9A, 9C and 9E are the visualization of all the collected droplets parameters, and FIGS. 9B, 9D and 9F are the visualization of the averaging smoothing.

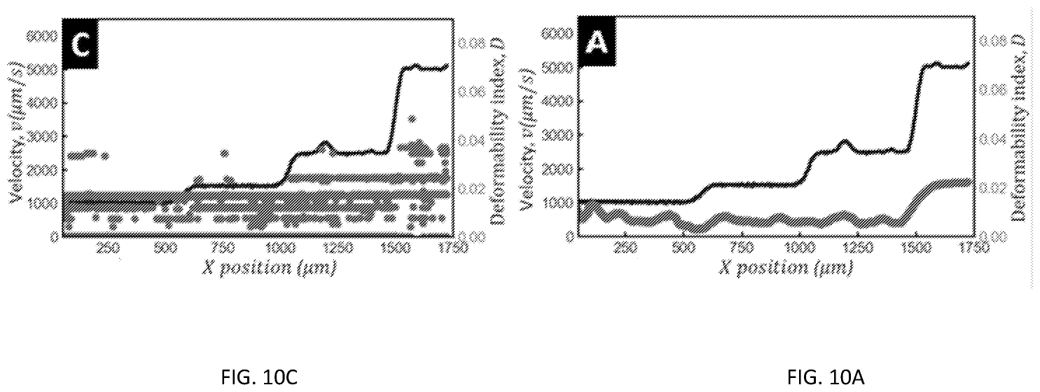

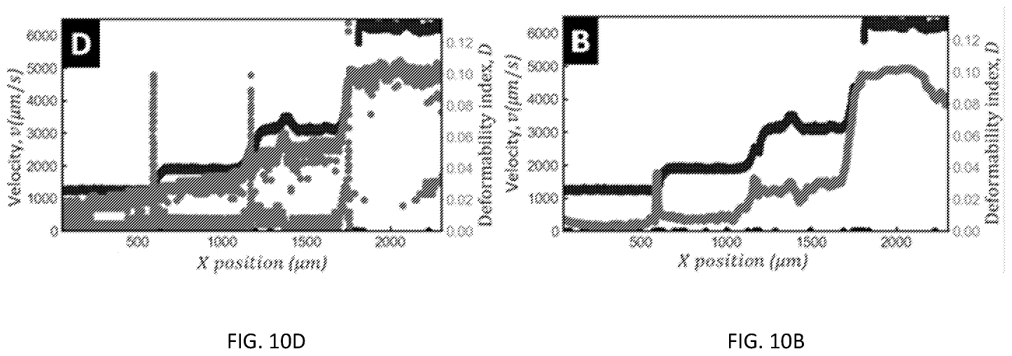

Referring now to FIGS. 10A-10D, plots of droplets velocity and deformability index with respect to x-position in the microfluidic channel are presented. FIGS. 10A and 10C are the results from the 5× objective, where FIG. 10A presents the results averaging smoothing, and in FIG. 10C, we plot the initial results.

Referring to FIGS. 10B and 10D are the results from four 20× objectives experiments cascading together, where 10B presents the results averaging smoothing, and in 10D, the initial results are plotted.

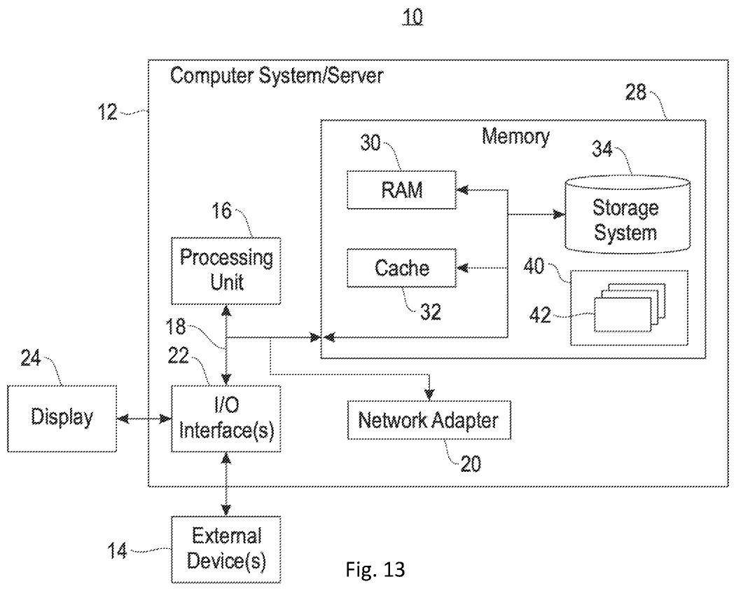

As shown in FIG. 13, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, may be signals, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

1. A microfluidic device, comprising:
a first stage comprising:
a first channel having a first end having a first neck junction and a second end, defining a channel length extending along a first direction therebetween, the first channel having a first width that expands from the first end to the second end in a direction perpendicular to the first direction;
an aqueous stream inlet in fluid communication with the first channel at the first neck junction, the aqueous stream inlet configured to provide a fluid to the first channel;
a first oil stream inlet in fluid communication with the first channel disposed at the first neck junction and at an angle to the aqueous stream inlet; a second stage comprising:
a second channel having a first end having a second neck junction and a second end, defining a second channel length therebetween, the second channel in fluid communication with the first channel;
a second oil stream inlet in fluid communication with the second channel proximate to a second neck junction at the first end,
the second channel having a second width that narrows from the second neck junction to the second end.

2. The microfluidic device of claim 1, wherein the second width of the second channel at the second neck junction is greater than the second end of the first channel.

3. The microfluidic device of claim 1, wherein the first width of the first channel expands linearly from the first end to the second end.

4. The microfluidic device of claim 1, wherein the first neck junction comprises two distinct first oil inlets disposed on either side of the aqueous stream inlet perpendicular to the first direction.

5. The microfluidic device of claim 1, wherein the second neck junction comprises two distinct second oil inlets disposed on either side of the first end of the second channel perpendicular to the first direction.

6. The microfluidic device of claim 1, wherein the aqueous stream inlet is configured to produce droplets into the channel along the first direction.

7. The microfluidic device of claim 1, wherein the second channel is configured to narrow along the first direction in stages.

8. The microfluidic device of claim 1, wherein the second channel is configured to narrow along the first direction in four stages, each subsequent stage having a second width of 200, 160, 120 and 80 micrometers, respectively.

9. The microfluidic device of claim 1, wherein the second channel length is approximately 2100 micrometers.

10. The microfluidic device of claim 1, wherein the first channel and the second channel comprise a channel height perpendicular to the first and second channel lengths and the first and second channel widths, wherein the channel height is approximately 32 micrometers.

11. The microfluidic device of claim 1, wherein the second width ranges from 190-70 micrometers.

12. The microfluidic device of claim 1, wherein the aqueous stream inlet is configured to provide deionized water that forms droplets.

13. The microfluidic device of claim 1, wherein the first oil inlet and the second oil inlet are configured to provide mineral oil mixed with a surfactant to the first channel and the second channel.

14. A method for measuring surface tension of a droplet, the method comprising:
providing an oil solution to a channel, the channel having a first neck junction and a neck junction, wherein the oil solution flows through the channel from the first neck junction at a first end, through a second neck junction to a second end;
generating a plurality of droplets in the channel at the first neck junction, the plurality of droplets flowing through the channel within the oil solution, wherein the channel comprises four stages of decreasing widths, the four stages extending from the second neck junction to the second end;
capturing at least one image of the plurality of droplets flowing through the channel; analyzing the at least one image of the droplets flowing through the channel; and calculating a surface tension of the plurality of droplets.

15. The method of claim 14, wherein the plurality of droplets flow through the four stages of the channel, each stage configured to impart increasing shear stress to the plurality of droplets as they flow through the channel.

16. The method of claim 14, wherein capturing at least one image of the plurality of droplets comprises capturing a video of the plurality of droplets flowing through the channel.

17. The method of claim 14, wherein the video is captured at approximately 91-167 Hz.

18. The method of claim 14, wherein capturing at least one image of the plurality of droplets comprises capturing the at least one image via a microscope.

19. The method of claim 14, wherein the microscope includes an objective between 5-20×.

20. The method of claim 14, wherein the microscope comprises a 5× objective with a resolution of approximately 1 pixel per micrometer configured to capture the at least one image of all four stages of the channel simultaneously.

21. The method of claim 14, wherein, the microscope comprises a 20× objective with a resolution of approximately 3.33 pixels per micrometers configured to capture the at least one image of a single stage of the channel.

22. The method of claim 14, wherein generating a plurality of droplets comprises provided deionized water to the channel at a driving pressure of between about 3001000 mbar.

23. The method of claim 14, wherein providing an oil solution to the channel comprises provided the oil solution to the channel at a driving pressure of between about 10002000 mbar.

24. The method of claim 14, further comprising pre-flushing the channel with a hydrophobic coating.

25. The method of claim 14, wherein analyzing the at least one image of the plurality of droplets comprises binarizing the at least one image and identifying at least one contour of each of the plurality of droplets.
